(19) United States
(12) Patent Application Publication
(10) Pub. No.: US 2001/0030539 A1
(43) Pub. Date: Oct. 18, 2001

(54) Method and system for monitoring of water movement in the subsurface during secondary recovery of hydrocarbons

(76) Inventors: Jerry R. Montgomery, West Valley City, UT (US); Sarah Elle Montgomery Parry, Salt Lake City, UT (US); Nathan Rich Montgomery, Kemmerer, WY (US); Marion Wynne Bruening, Riverton, UT (US)

Correspondence Address: Lloyd W. Sadler, MCCARTHY & SADLER, LC, 39 Exchange Place, Suite 100, Salt Lake City, UT, 84111, US

(21) Appl. No.: 09/798,410

(22) Filed: Mar. 2, 2001

Related U.S. Application Data
(60) Provisional application No. 60/186,957, filed on Mar. 5, 2000.

(51) Int. Cl. G01V 3/18

(52) U.S. Cl. 324/324

(57) ABSTRACT

A magnetic method is disclosed that can be used to map, track and monitor the progress of secondary oil recovery during water or steam floods. An electric current is injected directly into the water hydrocarbon system to be monitored. The electricity that flows in the water creates a magnetic field, which can be monitored. Monitoring the changes in the magnetic field monitors the changes in the water flooding the subsurface hydrocarbon zone. The resulting surface magnetic field is measured at various time intervals. Variation in magnetic field is used to interpret and determine the status of the hydrocarbon recovery zone.

### CROSS REFERENCE TO RELATED APPLICATIONS

This application is based on Provisional Application Ser. No. 60/186,957, which was filed on Mar. 5, 2000, and priority is claimed thereto.

### BACKGROUND OF THE INVENTION

1. Field of the Invention

This invention relates to the use of magnetic fields to map and monitor the progress of secondary oil recovery during water or steam floods. Electrical current is injected into the water in the horizon that is being flooded. The water conducts electricity and the hydrocarbons do not. The electricity that flows in the water creates a magnetic field, which can be monitored. Monitoring the changes in the magnetic field monitors the changes in the water flooding the subsurface hydrocarbon zone. Changes in the magnetic field indicate where the water has moved which indicates the change of position or apparent motion of water in the horizon being flooded. More specifically it relates to a method to map, track, and monitor the movement and progress water and/or steam during secondary recovery of hydrocarbons.

2. Description of prior art

There are currently three primary techniques for monitoring water during water floods. The first is to track the amount of oil and water recovered in production wells and compare that to the quantity of water being injected into the system. Then computer models are created which include known information about the formation being flooded. This results in a model that is the best educated guess of what is currently occurring in the production horizon. The disadvantage of only monitoring the flow rates is that if the ground is not homogeneous then valuable pockets of hydrocarbon might not be recovered.

The second involves different types of well logs, which provide information in the near vicinity of the hole. The disadvantage of using well loges is that they do not penetrate very deep into the structure thus they have a limited resolution and valuable pockets of hydrocarbon might be overlooked during the secondary recovery process.

The third technology is resistivity tomography. This involves taking readings using a series of electrodes exchanging them for energizing and reading function until all possible combinations have been used. The resulting data is then reduced in a computer program to create a cross sectional topographic image of the oil reservoir and injected water. This is the best of the three technologies and does provide a reasonable picture of what is occurring in the hydrocarbon reservoir.

The primary concept of this invention is to electrically connect directly to the water being injected into the hydrocarbon horizon. Thus the water in that horizon becomes the transmitting antenna, which results in an enhanced signal that is only related to the water in the flooded horizon. The difference is that this invention is based on magnetic data rather than resistivity data.

The idea of directly connecting or nearly directly connecting to an ore body is utilized in the Mise-a-la-masse method. In the method of this present invention, galvanic resistivity or induced polarization (IP) is used as a detection mode and the technique does not require the electrodes to be in contact with the body being studied (Beasley, C. W., and S. H. Ward, 1986, “Three-dimensional Mise-a-la-masse Modeling Applied to Mapping Fracture Zones,” Geophysics vol. 51 p. 98-113, the contents of which are hereby incorporated by reference). Mise-a-la-masse technology is utilized for detection of mineralization that was just missed by drilling.

All of the classical geophysical methods for monitoring subsurface water or solutions were tried in tests conducting by the Bureau of Mines, Sandia National Laboratories, University of Arizona and Zonge Engineering. Tests were conducted on copper mineralization located near Casa Grande, Ariz. using the best known geophysical resistivity and electromagnetic technologies for tracking groundwater or underground solutions (Tweeton, D. R., J. C. Hanson, M. J. Friedel, B. K. Sternberg, and L. J. Dahl, “A Field Test of Electromagnetic Geophysical Techniques for Locating Simulated In Situ Mining Leach Solution,” Dept. of Interior, Bureau of Mines, R.I. 9505, 1994, the contents of which are hereby incorporated by reference). These tests represent the state-of-the-art in geophysical methods currently practiced in the field.

A method to map groundwater plumes using electrical resistance tomography (ERT) and electro kinetic system (EKS) was developed by researchers at the University of California, Oakland, (U.S. Pat. No. 5,495,175, dated February 1996, A. L. Ramirez, J. F. Cooper, and W. D. Daily, hereinafter the “175” patent, the contents of which are hereby incorporated by reference). The method places many electrodes on the surface and in wells and measures all combinations of resistivity between them. Then, the water or fluids are caused to move using electro kinetics and subsequently the many resistivity combinations are remeasured. The data is then combined to create a tomography picture that results from the displacement of the plume. The “175” patent uses only resistivity and tomogrpahy.

Technology has been developed that uses electromagnetic energy to locate underground pipes and wire (U.S. Pat. No. 4,063,161, dated December 1977, R. J. Pardis, the contents of which are hereby incorporated by reference).

Technology to map groundwater has been previously patented by the author, Jerry R. Montgomery (U.S. Pat. No. 5,825,188 dated October 1998, hereinafter the “188” patent. The contents of which are hereby incorporated by reference). The invention described herein embodies a new and novel application of the principle described in the “188” patent. The “188” patent describes an invention to map groundwater systems such as springs, near surface pollution in groundwater, groundwater channels and systems, and other near surface aqueous systems.

### SUMMARY OF THE INVENTION

An electric current is fed directly into the water or steam that is being injected into a hydrocarbon reservoir. The electrical current flows in the water but not the hydrocarbon. Current flowing in the water generates a magnetic field. The magnetic field is measured and mapped. By mapping the magnetic field the water carrying the current that is creating the magnetic field is mapped.

As the water replaces the hydrocarbons in the reservoir, current flow in the subsurface will change. When the current flow in the subsurface changes, the resulting magnetic field will change. By measuring the amount of change in the magnetic field the amount of change in the water in the hydrocarbon reservoir can be monitored. The change in where the water is will permit the monitoring of movement in the hydrocarbon reservoir. Also if zones of hydrocarbon are missed during flooding, the data from the magnetic field will indicate that no water is present in that location. Actions can then be taken to recover the missed hydrocarbons.

To track the water and create a magnetic field measurable at the surface, which will, emanates from the groundwater being monitored; at least one electrode must be placed in direct contact with the hydrocarbon reservoir to be investigated. A second electrode is placed in an appropriate position to provide a return path for the current. The second electrode does not need to be in contact with the said system. The system is arranged so that the flow of current is roughly in a large vertical loop. This facilitates interpretation of the watercourse because the magnetic field produced and monitored can be treated as one part of a simple loop, see FIG. 1. The electric field in this leg can be treated as a dispersed current. An electric or potential map is created from the magnetic data to outline the diffused current and locate which direction the water is moving in the reservoir.

The electrodes are connected to a controlled source of pulsed DC or AC current. Power is provided by a generator, also referred to as the transmitter or generator base station. The current is filtered and controlled to provide a locked pulse or frequency between the transmitter and receiver. Output voltage and current in the loop are controlled, monitored, and recorded during the survey, and corrected for any transmitter drift. All readings are locked to a base station and corrected for diurnal drift.

Data is collected at each magnetic field detection station using special receivers. The receiver for measuring the magnetic field consists of: (1) a coil or other magnetic field measuring device or generate a signal from the magnetic field flux passing through he detecting device, (2) a mechanism to level the detector, (3) a mechanism to move the detector between the horizontal and vertical positions, (4) a mechanism to rotate the detector when positioned in the horizontal or vertical position, (5) an apparatus for measuring the bearing of the detector, (6) filters and tuning circuits to filter out all extraneous fields (noise) fluctuating at any frequency other than transmission frequency, and (7) amplifiers and multipliers to produce a signal that can be displayed and recorded.

The magnetic signal picked up in the detector is correlated with the transmitter signal and filtered for noise. The correlated amplifier signal induced by the magnetic field at each detection site is measured. Magnetic field measurements consist of magnitude and direction of all magnetic field components. Magnetic field direction is obtained by determining the orientation of the receiver, see FIG. 3. The orientation of the magnetic detector may be placed, sequentially, in three axes to measure the maximum magnetic field occurring in each particular axis, or three detectors could be used, such as two coils in a horizontal plane orientated at 90° to one another and a third coil vertically oriented.

Using vector analysis, distance corrections, profile plots, modeling, contouring, and other reduction methods described later, the relevant properties of the magnetic field at each station are thus calculated and plotted. Using all or part of this data, depending on the subsurface information needed, it is possible thus to map the subsurface path and activities of water during water or steam floods of a hydrocarbon reservoir using readings taken from the surface or in drill holes.

### BRIEF DESCRIPTION OF DRAWINGS

FIG. 1 schematically illustrates a typical circuit diagram of the invention for creating and measuring the magnetic field associated with monitoring the water movement in a hydrocarbon reservoir.

FIG. 2 schematically illustrates a typical circuit diagram of the invention for measuring flooding progress in a subsurface hydrocarbon reservoir system. The circuit loop is vertical in this case, but conceptually similar to the primary loop of a single turn air core transformer.

FIG. 3 is a grid diagram.

FIG. 4 is a block diagram of instrumentation used by this invention to measure the magnetic field and its component.

### DETAILED DESCRIPTION

The invention described herein uses magnetic fields to map, track and monitor water moving in a hydrocarbon reservoir during secondary recovery operations such as water or steam floods. Steam condenses to hot water in the flooded reservoir and thus the principles for steam are the same as what would happen for a water flood.

Something to note with this technology is that it does not matter whether the water is moving or stationary and pooled. Any water mixed in the hydrocarbons can be detected and monitored regardless of motion.

This technology uses the magnetic field produced by a precisely controlled electrical current introduced into the water that is in the hydrocarbon reservoir. The electric current thus flows in the water conductor, which creates a magnetic field around the conductor, which is the water. By monitoring the magnetic fields, the path, location and movement of the water can be monitored. The changes that occur in the magnetic fields and how they vary with time can be used to map and monitor activity within the hydrocarbon reservoir such as seasonal fluctuations, pumping, water movement, chemical or biological reactions that are taking place. Because this technology directly energizes the target horizon, there is confirmation that the signal being measured is coming from the designated or desired target.

The most elementary model which demonstrates the principle of how this technology works is to consider what happens which electric current flows in a wire. A magnetic field is produced that circles the wire. The direction and character of magnetic fields are defined by the well-known “right-hand rule.” If conductive water replaces the wire, a magnetic field will form around the water. On the surface the magnetic field will be horizontal and perpendicular to the conducting zone just as it would be for a wire. This is also true for a curved conductor. The strongest horizontal field strength and weakest vertical field will be measured directly over the conductor. When measured, the magnetic field traces a path on the surface that follows the path of the conductor (i.e. water) that is in the hydrocarbon reservoir.

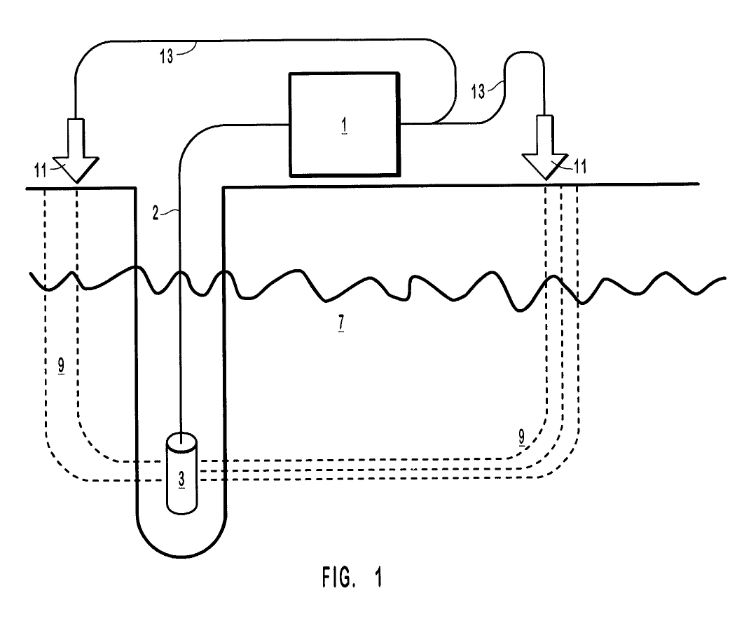

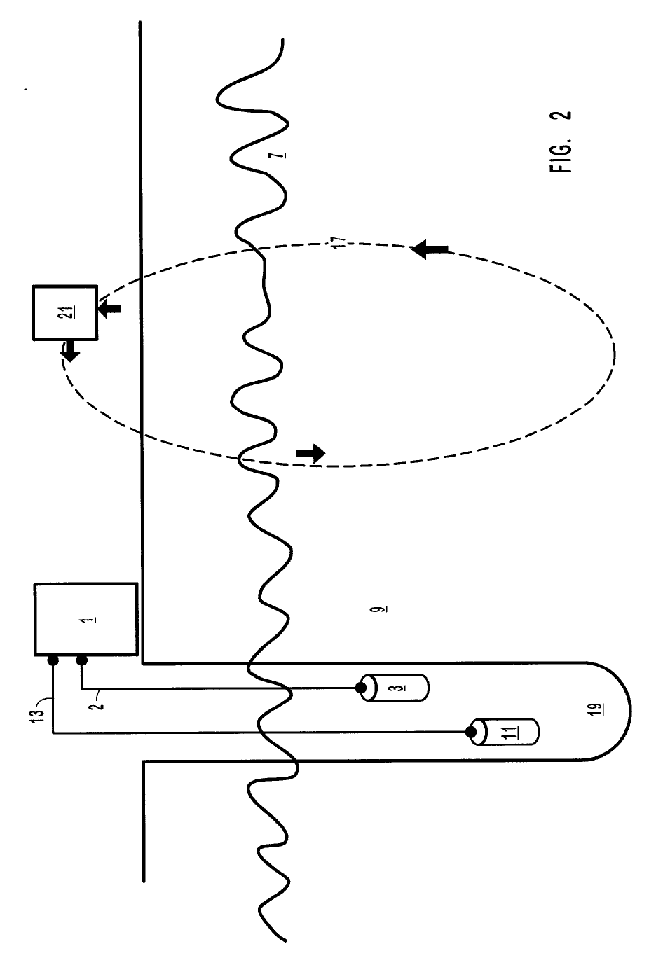

FIG. 1 schematically illustrates the invention for use in measuring. A generator 1 is connected to the energizing electrode 3. The electrode 3 is then placed in the water 7 in the hydrocarbon reservoir. The water electric current path 9 is shown as a dotted line passing from the water 7 and returning to the return electrodes 11. The return electrodes 11 are connected to the generator 1 via a connecting wire 1 3, which completes the electric loop. The electrical circuit typically includes instruments for measuring the electrical current injected and at what frequency is used to stimulate the system. Such instruments usually include a voltmeter, an ammeter, a signal analyzer, etc. Elementary electromagnetic theory teaches that when current flows through a loop of wire, magnetic field flux lines will pass through the electric current loop in accordance with the “right-hand-rule.” FIG. 2 schematically illustrates the use of the invention for measuring subsurface hydrocarbon reservoir systems. In FIG. 2, the generator 1 is connected to the energizing electrode 3, which energizes water 7 at the target horizon or depth. The energizing electrode 3 and the return electrode 11 is located in a well 19. The electric current path 9 is represented by dotted lines passing through the water to the return electrode 11 at a point below the water 7. Conceptually, it would also be possible for the return electrode 11 to be above the target horizon instead of below, however this arrangement result in a degradation of the signal of interest. The electric current loop is completed by connecting the generator 1 to the return electrode 11 by a connecting wire 13 through the well 19. Again, the magnetic field loop 17 will pass through the electric current loop flowing in the ground 9, allowing measurement by a detecting device 21.

To create a current flowing in the water, an electrode is placed in the reservoir to be studied. In the least complicated situation, a signal electrode in the water or site of interest would produce the strongest signal from the conductor. However, in the real world there are no mono poles and a second electrode is required. An important part of this technology is that the water or medium of interest is directly energized. Direct energizing of such a target can be accomplished in several ways but ultimately all achieve the same effect. The magnetic signal that is measured at any point in the survey is a compilation of the current flowing in the earth and the field created by the wires leading to the electrodes energizing the water.

The circuit formed is a large single turn loop consisting of: the electrode in the groundwater, the wire connecting it and a set of return electrodes, the return electrodes, and the groundwater between the electrodes, see FIG. 1. This loop creates the equivalent of a single turn primary coil of an air core transformer. Thus, theory developed for electric and magnetic fields produced by a single turn loop can be used to interpret this data. However, the application of this theory to water floods in oil reservoirs is unique. This technology in particular deals with that portion of the single turn loop that is formed by the completion of the circuit via the water, the grounded portion of the loop. The grounded portion of this loop creates magnetic fields that are controlled by how the water is distributed in the area between the electrodes. The magnetic field strength will be directly proportional to the current in the water and inversely proportional to the distance above the water. Surface measurements made of both the magnetic field strength and the direction of the magnetic field provide information concerning the position, orientation, and conductivity of the water.

This invention is based on the concept that electrical current injected into a water source will preferentially follow the water because it is the best conductor. If no other factors influence the electric current, the magnetic field measurements at the surface will be strongest at the point closest to the water generating the field. This permits the tracing of the underground path through the use of surface maps made from measurements at numerous surface locations of the magnetic fields produced by the underground conductor.

The technique of this invention uses either direct (DC) or alternating (AC) current. A constant DC current source produces a field that is harder to detect with available field measuring equipment, although the use of a Josephsen Junction superconductor magnetometer can be used for such a purpose. AC or pulsed DC current sources provide a stronger signal, but introduce other factors that must be corrected. Inductive effects arising from pulsed DC or AC current may result in the excitation of remote conductors. Inductive effects increase the field attenuation rate, cause refraction at the earth's surface, and generate secondary out-of-phase magnetic fields that complicate the measurements. The resultant field from two or more out-of-phase magnetic fields will be “elliptically polarized.” Thus, it is necessary to completely describe this field by measuring the direction and amplitude of both the major and minor ellipses axes, and their phase relationship with the respect to the electrode current. The signal from the desired source is enhanced because of the direct energizing of the solutions to be studied. The signal is further enhanced by using a source that is time or frequency locked to the receivers used to map the magnetic fields.

There are three large sources of noise in the ground that must be accounted for when analyzing magnetic field measurements. The first results from power companies, which use the earth for their return circuit for all their power distribution. Thus, as usage changes during the day, the magnetic field produced by the returned electrical power will shift and change the magnetic field produced. Frequency locks between transmitter and receiver and corrections obtained from multiple base stations used to monitor the magnetic fields screen these effects. The second strongest noise source is from telluric currents created by the electrical currents that the sun generates in the ionosphere. Multiple readings at a base station also help eliminate these influences. The third electrical noise source is distant thunderstorms. The electrical static generated by lightning strikes becomes trapped in a wave-guide between the ground and the ionosphere. Over distance, the currents generated begin to blanket the magnetic spectrum usable in this technology. This noise is corrected using both frequency locks and base station corrections. Frequencies utilized in this invention are selected as ones, which are substantially different than any potential interfering or background frequencies.

While the use of magnetic fields to track water is based on sound theory, its practice can be quite difficult. Nearby power lines or buried cable will produce their own fields and need to be accounted for. The depth of the water from the surface will cause variations in the field measurements. Other potential influences include changes such as increases or decreases in the ion concentration. Information concerning the physical properties at the site must be taken into consideration when a study is undertaken and factored into interpretation of the data.

Analysis or interpretation of the data is a multifaceted process. The data is corrected for diurnals, current drift, and any base intensity changes. For example, to correct a diurnal, it is monitored at a base station and the amount of drift or change from the original reading at the base station is added algebraically to each reading at receiver stations. Current drift of the transmitter is a linear effect on the reading. The percent of drift of the current is used as a multiplying factor and applied to the field reading for correction. Base intensity changes are due to changes in the conducting medium and can be either algebraically factored into the field reading or treated like current drift. The anomalies and interpretation can be facilitated and enhanced by the various treatments.

To collect data, the generator 1, energizing electrode 3, return electrodes 11 and connecting wire 13 are placed on the site under investigation, as shown in FIG. 1. The generator 1 is generally located near the energizing electrode 3 for convenience. In this example, the energizing electrode 3 is placed directly into contact with the water. The return electrodes 11 are placed to provide a return path for the current once it leaves the area of interest.

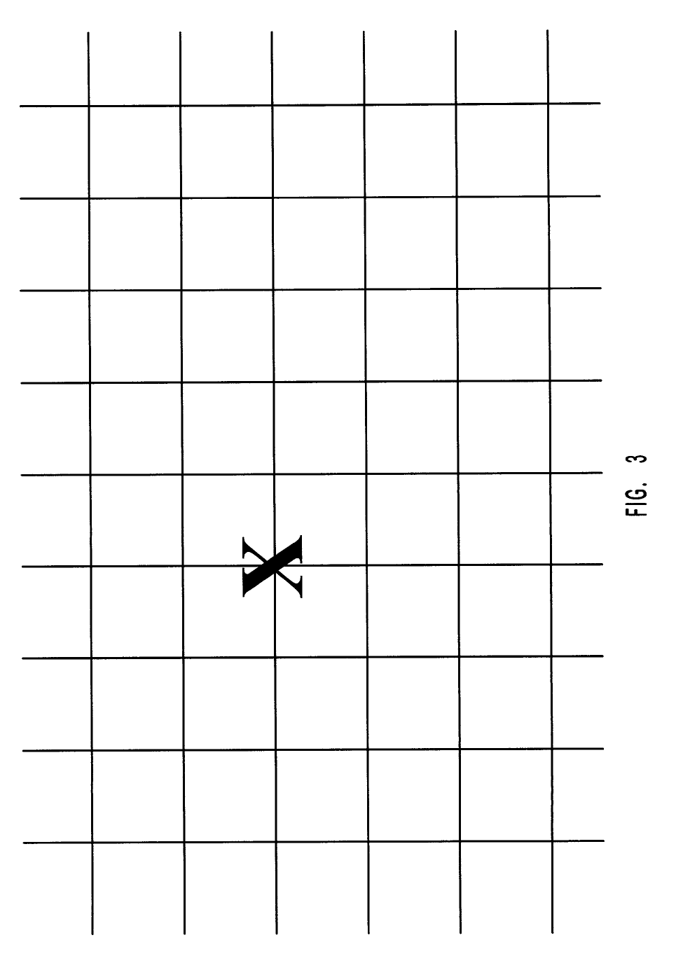

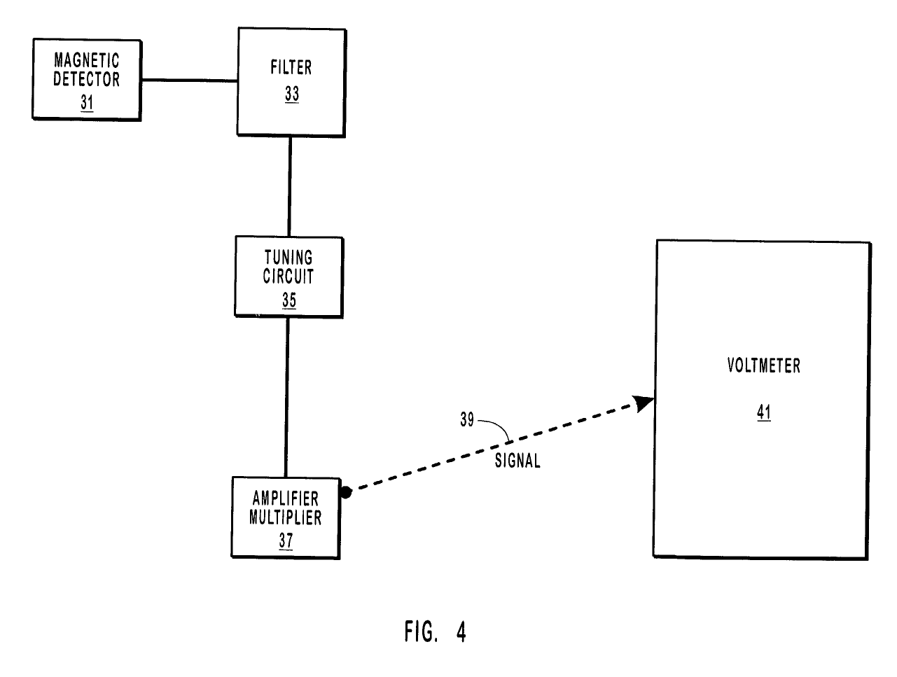

FIG. 3 also depicts a grid 23 on regular intervals 27, marked with “X” encompassing the area to be studied. Measurements are then taken at each point on the grid 23 using a receiver (not shown in FIG. 3, but shown schematically in FIGS. 2 and 4). Grid spacing is somewhat arbitrary, however, smaller spacing provides improved definition of the area under investigation. Grid spacing as little as 10 feet to as large as 200 feet have been used successfully in test. Grid spacing outside this range should work as well, and are not precluded theoretically. In FIG. 3, the initial grid point is marked with an “X”.

FIG. 4 is a block diagram of the receiver 25 used to measure the magnetic field at each of the grid points 27 of FIG. 3. The receiver 25 is diagramed in FIG. 4 and consists of a detecting coil 31, a filter circuitry 33, tuning circuitry 35, amplifiers and multipliers 37 to produce a signal 39 representing the relative maximum field intensity measured by voltage. These circuit components are merely representative of electronics necessary to measure a magnetic field indirectly through the current induced in a detecting coil. A magnetic detecting device can replace the detecting coil.

As described above and illustrated in FIGS. 1-4, this invention includes an apparatus for electrically energizing water in a hydrocarbon reservoir system and for measuring the resulting magnetic fields emanating from the energized subsurface system for use in mapping and monitoring the reservoir system. The electronics typically include a transmitter capable of generating an electrical signal, preferably of a preselected frequency, a primary energizing electrode in contact with the system, an electrical conductor that connects the transmitter to a primary electrode, a secondary return electrode, a subsurface water solution located in a hydrocarbon reservoir and between the primary and the secondary return electrode, an electrical conductor connecting the secondary or return electrode to the transmitter, at lease one receiver capable of measuring a surface magnetic field emanating from the subsurface hydrocarbon reservoir system when the transmitter is activated to generate an electrical current to impose a current that flows in the hydrocarbon reservoir system, and a signal process to process and record measured magnetic data.

The receiver to measure the magnetic field typically includes a coil or some other magnetic detection device to generate a signal when a magnetic field flux passes within the coil (in alternative embodiments, any magnetic detector can be substituted for the coil), a mechanism to level the coil, a mechanism to move the coil between horizontal and vertical positions, a mechanism to rotate the coil in either the horizontal position or the vertical position, and a device to measure compass coordinates of said coil.

A typical signal processor useful in this invention includes a tuning circuitry to adjust phase and frequency of measured field signals, filter circuitry to exclude undesired frequency components from said field signals, amplification circuitry to display processed signals, and memory storage to record measured data and processed data.

Structurally, a preferred receiver to measure magnetic fields detected according to the invention includes a horizontal coil to generate a signal when magnetic field flux passes within the horizontal coil, a vertical coil to generate a signal when magnetic field flux passes within the vertical coil, a mechanism to level the horizontal coil, a mechanism to level the vertical coil, a mechanism to rotate the horizontal coil about a horizontal axis, a mechanism to rotate the vertical coil about a vertical axis, a mechanism to measure the angular direction of the coils, and a device to measure compass coordinates of the receiver, and in a sophisticated embodiment of the invention may include three coils, or three magnetic detection devices, in fixed orthogonal relative orientation, a mechanism to level the fixed three detectors, a mechanism to orient and measure the angular coordinates of the fixed three detectors, and a device to measure compass coordinates of the receiver.

The coils used in the practice of this invention are very sensitive to small amounts of magnetic fields. Preferred coils have thousands of turns of wire about the central core, which is typically a ferromagnetic material. Any of the other magnetic field detection devices should also be very sensitive.

A preferred transmitter is one capable of generating an electrical signal of one or multiple preselected frequencies and capable of generating an electrical signal varying with an ideal current of 0.1 to 10.0 amps which may require a voltage of 0.1 to 1000 volts. These are the normal or typical ranges but can be more or less depending on the specific site conditions.

A preferred signal processor for use in the apparatus of this invention comprises a computer used to tune, filter, amplify, display, and record the measured signals, the angular coil coordinates and the measured receiver compass coordinates.

To monitor a site over time, these measurements should be repeated at regular intervals, such as every two weeks or every two months, and the data then compared. Comparing the changes in the various components of magnetic field over time provides information relating to water movement, changes in chemical activity, changes in subsurface biological activity, movement of chemical or bio-reaction fronts, leaching progress and activity, increases or decrease in subsurface flow, changes in salinity, or any change in the water that affects any of its electrical properties. The field intensity readings are mathematically normalized for distance from the energizing electrode. As current flows through the water, some electrical current leaks into the surrounding medium. The electrical contrast between the water in the reservoir and host rock can be evaluated by the rate at which the magnetic fields degrade. The data can be enhanced by applying distance correction factors.

The measured magnetic fields are used to construct a model of the electrical current flow in the reservoir resulting from the current introduced at the energizing electrode. The resulting electrical model is then used to determine the water configuration being energized. All data and the resulting maps are evaluated by an interpreter skilled in the art to locate and map the activity of the subsurface reservoir being monitored.

When using this technology to monitor activity such as movement, it is necessary to establish a reference survey. This reference survey is a base to which all subsequent surveys may be compared. The difference between the fields measured for the separate surveys are used to evaluate and determine the extent and magnitude of subsurface changes in the reservoir under observation.

It is further understood that this invention is not be limited to the specific embodiments set forth herein by way of exemplifying the invention. Rather, the invention is to limited only by the scope of the attached claims, including the full range of equivalency which each element or step is thereof entitled. It should further be apparent to those skilled in the art that various changes in form and detail of the invention as shown and described may be made within the scope of the invention. It is intended that such changes are included within the spirit and scope of claims appended hereto.

1. An apparatus for electrically energizing the water in a hydrocarbon reservoir that is being flooded with water or steam for secondary or other scheme for post recovery of hydrocarbons and measuring resulting magnetic fields emanating from said energized subsurface water and hydrocarbon system for use in mapping and monitoring said secondary hydrocarbon recovery system comprising:
a transmitter capable of generating an electrical signal;
a primary energizing electrode in contact with said water and hydrocarbon system;
an electrical conductor connecting said transmitter to said primary electrode;
a secondary return electrode;
a subsurface water flood solution, located between said primary and second secondary return electrodes;
an electrical conductor connecting said secondary return electrode to said transmitter;
at least one receiver capable of measuring a surface magnetic field emanating from said hydrocarbon recovery system when said transmitter is activated to generate an electrical current to impose a voltage upon the system; and
a signal processor to process and record measured data.

2. The apparatus of claim 1, wherein said receiver that measures magnetic fields further comprises:
a magnetic field detecting device to generate a signal when magnetic field flux passes within said detector;
a mechanism to level said detecting device;
a mechanism to move said detecting device between horizontal and vertical positions;
a mechanism to rotate said detecting device in either the horizontal position or the vertical position; and
a device to measure the coordinates of said detecting device.

3. The apparatus of claim 1, wherein said signal processor further comprises:
a tuning circuit to adjust phase and frequency of a measured field signal;
a filter circuit to exclude an undesired frequency component from said field signal;
an amplification circuit to display a process signal; and
a memory storage to record measured data and processed data.

4. The apparatus of claim 1, wherein said receiver further comprises:
a horizontal coil to generate a first electric current when a magnetic field flux passes within said horizontal coil;
a vertical coil to generate a second electric current when a magnetic field flux passes within said vertical coil;
a mechanism to level said horizontal coil;
a mechanism to level said vertical coil;
a mechanism to rotate said horizontal coil about a horizontal axis;
a mechanism to rotate said vertical coil about a vertical axis;
a mechanism to measure the angular direction of said horizontal and said vertical coils; and
a measurement device to measure the compass coordinates of said receiver.

5. The apparatus of claim 1, wherein said receiver for measuring magnetic fields further comprises:
three magnetic detectors in a fixed orthogonal relative orientation;
a mechanism to level said three magnetic detectors;
a mechanism to orient and measure the angular coordinates of said three magnetic detectors; and
a measurement device to measure the compass coordinates of said receiver.

6. The apparatus of claim 1, wherein said signal processor further comprises a computer having functions selected from the group consisting of tune, filter, amplify, display and record.

7. The apparatus of claim 1, wherein said transmitter is capable of generating an electrical signal of a preselected frequency.

8. The apparatus of claim 1, wherein said transmitter is capable of generating an electrical signal varying in voltage from about 0.1 volts to about 1,000 volts and having a current between 0.1 amps and 10.0 amps.

9. A method for geophysical mapping, tracking and monitoring of a subsurface water system using magnetic energy, comprising:
introducing an electrical current into a subsurface water system to electrically energize said water system;
monitoring a magnetic field emanating from said water system;
measuring said monitored magnetic fields produced by said electric current; and
interpreting said measured signals to determine extent, change in location, and change in configuration of said water system.

10. The method of claim 9, wherein said introducing an electrical current further comprises introducing an electrical current selected from the group consisting of: direct current, pulsed direct current, alternating pulsed direct current, and alternating current.

11. The method of claim 9, wherein said introducing an electrical current further comprises introducing an electrical current that is locked with a receiver used to receive said magnetic fields.

12. The method of claim 9, wherein said subsurface water system is energized by placing an electrode in a cavity in a subsurface horizon that interacts with said system, and a secondary return electrode is placed below a target horizon of said subsurface water system.

13. The method of claim 12, wherein said secondary return electrode is located above said target horizon.

14. The method of claim 9, wherein said monitoring step further comprises measuring total magnetic field amplitude; total horizontal magnetic field amplitude; maximum horizontal magnetic field amplitude; minimum horizontal magnetic field amplitude; vertical magnetic field amplitude; gradient of the magnetic field; direction of total magnetic field vector; direction of maximum horizontal magnetic field; and direction of minimum horizontal magnetic field.

15. The method of claim 14, wherein said measurements are performed over at least two points in time to detect changes in said magnetic field and corresponding changes in said subsurface water system.

16. The method of claim 9, wherein said interpreting further comprises:
correcting for diurnals, current drift of a transmitter, and any base intensity changes;
determining a flow path of water injected in said water system from the minimum horizontal magnetic field direction or from perpendicular to maximum horizontal magnetic field;
comparing changes in a magnetic field over time;
normalizing electromagnetic field intensity readings for distance from an energizing electrode;
plotting data in profile form;
plotting data as a contour map;
conducting periodic surveys of measurements over time;
conducting a baseline reference survey; and
constructing a model of the electrical current flow in the water system from measured magnetic fields.

17. The method of claim 16, wherein said correcting for diurnals further comprises monitoring diurnal at a base transmitter station and the amount of drift or change from the original reading at the base transmitter station.

18. The method of claim 16, wherein correcting for the current drift of the transmitter further comprises determining the percent drift from original current and multiplying a linear factor against the measured field readings.

19. The method of claim 16, wherein said correcting for base intensity changes further comprises applying corrections to the measured field readings.

20. The method of claim 14, wherein said measurement of primary magnetic field is measured at a receiver station over two or more periods of time to monitor and detect changes in subsurface hydrocarbon recovery systems volume and quality caused by yearly or seasonal water table fluctuations; water table fluctuations due to pumping; groundwater quality; and quantity of subsurface water.
